(19) United States
(12) Patent Application Publication
(10) Pub. No.: US 2026/0245028 A1
(43) Pub. Date: Aug. 20, 2026

(54) Food Transportation Assistance System, Food Transportation Assistance Method, and Food Transportation System

(71) Applicants: Hitachi, Ltd., Chiyoda-ku, Tokyo (JP); Hokkaido Electric Power Co., Inc., Sapporo-shi, Hokkaido (JP)

(72) Inventors: Thantip Sirinabhigupta KRASIENAPIBAL, Tokyo (JP); Takahiro NAKAMURA, Tokyo (JP); Mai YONEMOTO, Tokyo (JP); Keisuke TERADA, Tokyo (JP); Takahiro AOYAMA, Hokkaido (JP); Takashi HOMMA, Hokkaido (JP); Shuto YUKI, Hokkaido (JP); Masato TAKAHASHI, Hokkaido (JP)

(21) Appl. No.: 19/160,548

(22) PCT Filed: Feb. 28, 2023
(86) PCT No.: PCT/JP2023/007379

§ 371 Date: Aug. 28, 2025

(51) Int. Cl. G06Q 10/0834; G06Q 10/04

(52) U.S. Cl. CPC G06Q 10/08345; G06Q 10/04

(57) ABSTRACT

A food transportation assistance system 20 including: an input device 24 that accepts shipping source information including first location information, which is location information of a plurality of shipping sources including plant factories, and information about food to be shipped by a shipping source, and shipping destination information including second location information, which is location information of a shipping destination, and information about food requested by the shipping destination; an arithmetic device 22 that finds a matching degree between the information about food which is included in the shipping source information and the information about food which is included in the shipping destination information, and transportation information when transporting the food from the shipping source to the shipping destination; and an output device 27 that outputs a candidate shipping source as candidate shipping information from among the plurality of shipping sources on the basis of the matching degree and the transportation information. Consequently, the food transportation can be made more efficient when the plant factories are included as the shipping sources.

### TECHNICAL FIELD

The present invention relates to a food transportation assistance system, a food transportation assistance method, and a food transportation system. The present invention particularly relates to, for example, a food transportation assistance system which can be used preferably when transporting food from a shipping source including a plant factory to a shipping destination.

### BACKGROUND ART

In recent years, food production by plant factories has been conducted. Generally, a plant factory has the advantages of having a degree of freedom regarding an installed location as compared to, for example, open-field cultivation and being capable of controlling harvest time.

PTL 1 discloses a method for reducing losses in production, distribution, and consumption processes of food and drink. This method includes: (A) a step of providing or producing food-drink raw materials; (B) a step of collecting production, distribution, and consumption information of the food-drink raw materials in the provision or production process, and collecting residue nonstandard information about nonstandard products and/or residues in the production, distribution, and consumption; (C) a step of collecting needs information about recipient consumers; and (D) a step of providing necessary substances to the recipient consumers with shortage, based on the production, distribution, and consumption information, the nonstandard products and/or the residue nonstandard information, and the needs information, wherein the necessary substances are provided from the food-drink raw materials or the nonstandard products and/or the residues.

### CITATION LIST

### Patent Literature

PTL 1: WO 2021/079999

### SUMMARY OF THE INVENTION

### Problems to be Solved by the Invention

However, conventionally, the advantages of plant factories have not been utilized and the plant factories which are shipping sources have not been selected. In this case, for example, there may occur a case where the food transportation is not performed efficiently, for example, by long-distance food transportation. Also, varieties which can be produced by plant factories are generally limited, so it is desirable to have a shipment form where food by existing farmers such as open-field cultivation and food produced by the plant factories are combined complimentarily.

It is an object of the present invention to provide a food transportation assistance system, a food transportation assistance method, and a food transportation system which are capable of making the food transportation more efficient when the plant factories are included as the shipping sources.

### Means to Solve the Problems

In order to solve the above-described problems, the present invention is a food transportation assistance system including: an input device that accepts shipping source information including first location information, which is location information of a plurality of shipping sources including plant factories, and information about food to be shipped by a shipping source, and shipping destination information including second location information, which is location information of a shipping destination, and information about food requested by the shipping destination; an arithmetic device that finds a matching degree between the information about food which is included in the shipping source information and the information about food which is included in the shipping destination information, and transportation information when transporting the food from the shipping source to the shipping destination; and an output device that outputs a candidate shipping source as candidate shipping information from among the plurality of shipping sources on the basis of the matching degree and the transportation information. In this case, when the plant factories are included as the shipping sources, the food transportation can be made more efficient.

Under this circumstance, the shipping source includes a virtual shipping location; and wherein the output device can output the virtual shipping location as a candidate installation location of a plant factory. In this case, it is possible to propose the candidate installation location of the plant factory which can make the food transportation more efficient. Moreover, the input device can accept a candidate for the virtual shipping location; and wherein the output device can output the candidate installation location of a plant factory selected from among accepted candidates for the virtual shipping location. In this case, an appropriate place can be designated as the candidate installation location of the plant factory.

Furthermore, the output device can output introduction efficiency when setting the plant factory as the candidate installation location. In this case, it is possible to recognize how much efficient the food transportation can be made.

Furthermore, the introduction efficiency can be decided based on a cost required for food transportation. In this case, computation accuracy of the introduction efficiency is enhanced. Moreover, the output device can further output a candidate delivery means that is a candidate for a transportation means when shipping the food from the shipping source to the shipping destination. In this case, it is possible to propose a method for making the food transportation including the transportation means more efficient.

Furthermore, the candidate delivery means can be decided based on a distance between the shipping source and the shipping destination, and the weight of the food to be transported. In this case, it becomes easier to select the candidate transportation means.

Furthermore, the arithmetic device can compute the matching degree based on a shippable quantity of the food which can be shipped from the shipping source, and a cost required when transporting the food from the shipping source to the shipping destination. In this case, computation accuracy of the matching degree is enhanced.

Then, the candidate shipping information can be sent to the shipping source in order to obtain an approval from the shipping source. In this case, it is possible to check the shipping source's will.

Moreover, the transportation information can be at least one of a transportation distance, a transportation means, and transportation time from the shipping source to the shipping destination. In this case, more appropriate information can be used as the transportation information.

Moreover, the present invention is a food transportation assistance method including, by execution of software recorded in a memory by a processor: accepting shipping source information including first location information, which is location information of a plurality of shipping sources including plant factories, and information about food to be shipped by a shipping source, and shipping destination information including second location information, which is location information of a shipping destination, and information about food requested by the shipping destination; finding a matching degree between the information about food which is included in the shipping source information and the information about food which is included in the shipping destination information, and transportation information when transporting the food from the shipping source to the shipping destination; and outputting a candidate shipping source as candidate shipping information from among the plurality of shipping sources on the basis of the matching degree and the transportation information. In this case, the food transportation can be made more efficient when the plant factories are included as the shipping sources.

Furthermore, the present invention is a food transportation system including: a first terminal device that inputs shipping source information including first location information, which is location information of a plurality of shipping sources including plant factories, and information about food to be shipped by a shipping source; a second terminal device that inputs second location information, which is location information of a shipping destination, and information about food requested by the shipping destination; and a food transportation assistance system that outputs candidate shipping information which is a candidate shipping source when shipping food from the shipping source to the shipping destination, wherein the food transportation assistance system includes: an input device that accepts the shipping source information and the shipping destination information; an arithmetic device that finds a matching degree between the information about food which is included in the shipping source information and the information about food which is included in the shipping destination information, and transportation information when transporting the food from the shipping source to the shipping destination; and an output device that outputs the candidate shipping source as the candidate shipping information from among the plurality of shipping sources on the basis of the matching degree and the transportation information. In this case, the food transportation can be made more efficient when the plant factories are included as the shipping sources.

### Advantageous Effects of the Invention

According to the present invention, it is possible to provide the food transportation assistance system, the food transportation assistance method, the food transportation system which can make the food transportation more efficient when the plant factories are included as the shipping sources.

### BRIEF DESCRIPTION OF DRAWINGS

FIG. 1 is a diagram illustrating an example of a food transportation system according to this embodiment;

FIG. 2 is a conceptual diagram illustrating a network of shipping sources and shipping destinations;

FIG. 3 is a diagram illustrating an overall configuration of the food transportation system;

FIG. 4 is a block diagram illustrating a functional configuration of a food transportation assistance system;

FIG. 5 is a flowchart illustrating basic operations of the food transportation assistance system;

FIG. 6 is a flowchart illustrating operations of the food transportation assistance system in consideration of a virtual plant factory;

FIG. 7 is a flowchart illustrating further details of shipping candidate search computation in step S503 in FIG. 5 and in step S603 in FIG. 6;

FIG. 8 is a flowchart illustrating further details of virtual plant factory efficiency computation in step S607 in FIG. 6;

FIG. 9(a) is a diagram illustrating shipping destination information and FIG. 9(b) is a diagram illustrating shipping source information;

FIG. 10(c) is a diagram illustrating food information managed by a shipping source and FIG. 10(d) is a diagram illustrating virtual plant factory information;

FIG. 11 is a diagram illustrating candidate shipping information and candidate delivery means;

FIG. 12(a) to (c) are diagrams illustrating screens for the shipping source to input shipping source information;

FIG. 13(a) to (c) are diagrams illustrating screens for a shipping destination to input shipping destination information;

FIG. 14 is a diagram illustrating a case where the candidate shipping information and the candidate delivery means shown in FIG. 11 are output to the shipping source;

FIG. 15(a) and 15(b) are diagrams illustrating screens for an administrator of the food transportation assistance system to input or edit a candidate installation location of a virtual plant factory;

FIG. 16 is a diagram illustrating a case where introduction efficiency is associated as virtual plant factory information;

FIG. 17 illustrates a case where information about the virtual plant factory is displayed.

### OVERALL EXPLANATION OF FOOD TRANSPORTATION SYSTEM 1

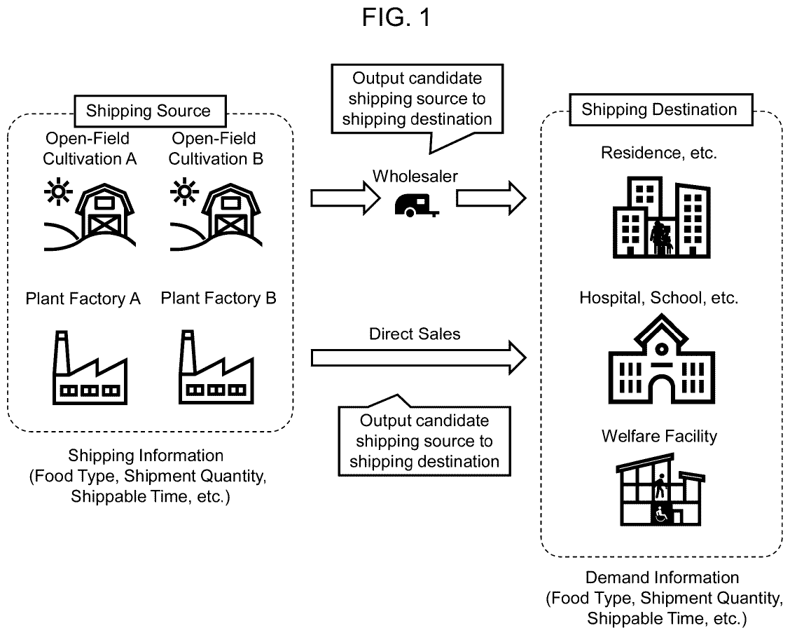

FIG. 1 is a diagram illustrating an example of a food transportation system 1 according to this embodiment.

The food transportation system 1 illustrated in FIG. 1 shows the case where food is transported between shipping sources and shipping destinations. The “shipping source(s)” herein used is a food producer(s) such as farmers who do open-field cultivation, and plant factories. Here, open-field cultivation A, open-field cultivation B, a plant factory A, and a plant factory B are indicated as their examples. The shipping source(s) provides shipping information which is information about the food to be shipped. The shipping information is, for example, the type(s) of the food to be shipped, a shipment quantity, and shippable time.

Moreover, the “shipping destination(s)” is a food consumer(s). Here, residences, schools, hospitals, and welfare facilities are indicated as examples of the shipping destinations. Then, in this embodiment, the shipping destination provides demand information which is information about the demand for requested food. The demand information is, for example, the type(s) of the requested food, the shipment quantity, and the shippable time.

Incidentally, regarding wholesalers, they can be recognized as shipping destinations, but they can also be recognized as shipping sources. Moreover, the shipping destinations may also include retailers such as supermarkets, department stores, and convenience stores.

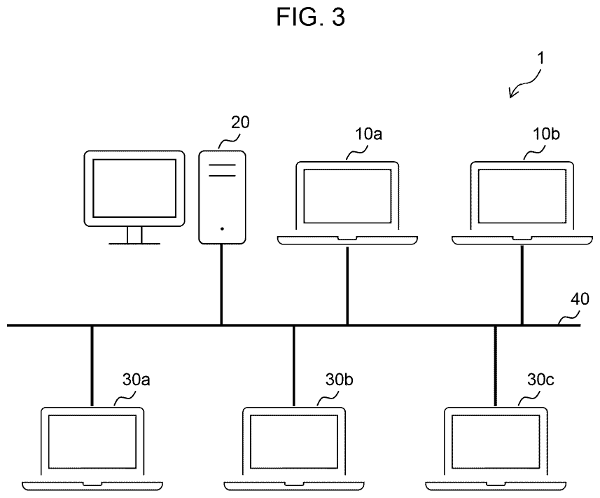

Then, in this embodiment, a food transportation assistance system 20 which will be described later with reference to FIG. 3 outputs a candidate shipping source to the shipping destination and provides information which makes the food transportation more efficient. Then, when the candidate shipping source is approved, the food is transported from the shipping source to the shipping destination. The transportation form is not particularly limited; however, a case where the food is transported from the shipping source to the shipping destination via a wholesaler and a case of direct sales from the shipping source to the shipping destination are illustrated here in the drawing.

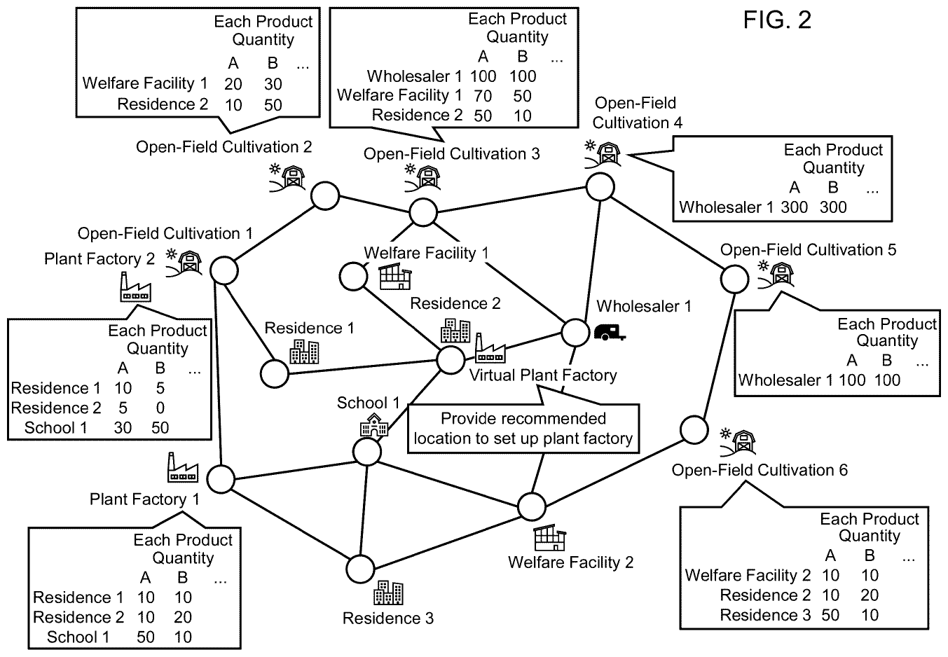

FIG. 2 is a conceptual diagram illustrating a network of shipping sources and shipping destinations.

In this diagram, open-field cultivation 1 to 6 are indicated as the shipping sources. Incidentally, no plant factory is indicated in this diagram, but plant factories may be included. Moreover, residences 1 to 3, school 1, and welfare facilities 1 to 3 are indicated as the shipping destinations. Furthermore, wholesaler 1 is indicated. Moreover, the details will be described later, but in this embodiment, a candidate installation location of a virtual plant factory which will make the food transportation more efficient (the virtual plant factory) is presented. The “virtual plant factory” is a plant factory which does not currently exist, but is proposed to be installed at the candidate installation location in future.

FIG. 3 is a diagram illustrating an overall configuration of the food transportation system 1. The food transportation system 1 illustrated in this drawing is configured such that terminal devices 10a, 10b which are examples of the first terminal device for the shipping source(s) to input the shipping source information, a food transportation assistance system 20 for managing the entire food transportation system 1, and terminal devices 30a, 30b, 30c which are examples of the second terminal device for the shipping destination(s) to input the shipping destination information are connected via a network 40.

Also, if the terminal devices 10a, 10b are not distinguished from each other below, they may be sometimes simply referred to as the “terminal device 10.” Moreover, if the terminal devices 30a, 30b, 30c are not distinguished from each other, they may be sometimes simply referred to as the “terminal device 30.”

Incidentally, in FIG. 3, there are two terminal devices 10 and three terminal devices 30, but there may be any number of such terminal devices.

The terminal device 10, 30 is, for example, a computer device such as a PC (Personal Computer), a mobile computer, a mobile phone, a smart phone, and a tablet.

The food transportation assistance system 20 is, for example, a server computer and performs various processing, which the food transportation system 1 is in charge of, and manages various kinds of information such as the shipping source information and the shipping destination information, the details of which will be described later. The food transportation assistance system 20 performs matching between the shipping source and the shipping destination based on the shipping source information and the shipping destination information and outputs candidate shipping information. The “candidate shipping information” is information about a candidate shipping source to ship food to the shipping destination.

Each of the terminal devices 10, 30 and the food transportation assistance system 20 includes a processor such as a CPU (Central Processing Unit) which is an arithmetic means, and storage such as a main memory and an HDD (Hard Disk Drive) which are storage means. The processor herein used executes various kinds of software such as an OS (basic software) and application programs (application software). Moreover, the main memory is storage areas for storing, for example, various kinds of software and data to be used to execute the software. Furthermore, the storage is storage areas for storing, for example, input data for the various kinds of software and output data from the various kinds of software.

Then, each of the terminal devices 10, 30 and the food transportation assistance system 20 includes a communication interface (hereinafter written as a “communication I/F”) for communicating with the outside and an input/output port for performing input/output to/from peripheral equipment. Moreover, they may also include a display mechanism composed of a video memory, a display, etc. and an input mechanism such as a touch panel.

The network 40 is a communication means used for information communication between the terminal devices 10, 30 and the food transportation assistance system 20 and is, for example, the Internet, a LAN (Local Area Network), or a WAN (Wide Area Network). Communication lines used for data communication may be either wired or wireless and both of them may be used together. Moreover, the terminal devices 10, 30 and the food transportation assistance system 20 may by connected via a plurality of networks and communication lines by using relay devices such as gateway devices and routers.

### Description of Food Transportation Assistance System 20

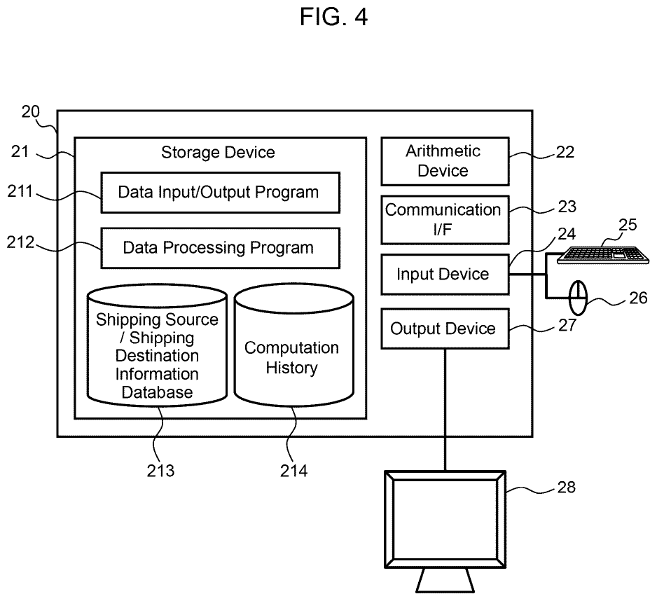

FIG. 4 is a block diagram illustrating a functional configuration of the food transportation assistance system 20.

The food transportation assistance system 20 illustrated in the drawing includes a storage device 21, an arithmetic device 22, a communication I/F 23, an input device 24, and an output device 27.

The storage device 21 corresponds to the main memory and the storage described earlier. Then, the storage device 21 stores: a data input/output program 211 which is a program for inputting/outputting the shipping source information and the shipping destination information; and a data processing program 212 for processing the shipping source information and the shipping destination information and finding, for example, a matching degree with respect to the information about the food. Moreover, the storage device 21 includes: a shipping source/shipping destination information database 213 which stores the shipping source information and the shipping destination information; and a computation history 214 which stores a history of processing results of the data processing program 212. The “shipping source information” is information about the shipping source(s) and includes the location information and the information about food of the shipping source(s). The “shipping destination information” is information about the shipping destination(s) and includes the location information and the information about food of the shipping destination(s).

The arithmetic device 22 corresponds to, for example, the aforementioned processor. The arithmetic device 22 executes the processing performed by the food transportation assistance system 20 by executing the data input/output program 211 and the data processing program 212.

The communication I/F 23 exchanges the shipping source information and the shipping destination information with the terminal devices 10, 30 via the network 40.

The input device 24 corresponds to, for example, the aforementioned input/output port. The input device 24 accepts input from the input mechanism such as a keyboard 25 and a mouse 26 connected to the food transportation assistance system 20.

The output device 27 corresponds to, for example, the aforementioned input/output port. The output device 27 displays necessary information on a display device 28 of, for example, a liquid-crystal display connected to the food transportation assistance system 20. Moreover, the output device 27 can output specified information to an external device via the communication I/F 23 and the network 40.

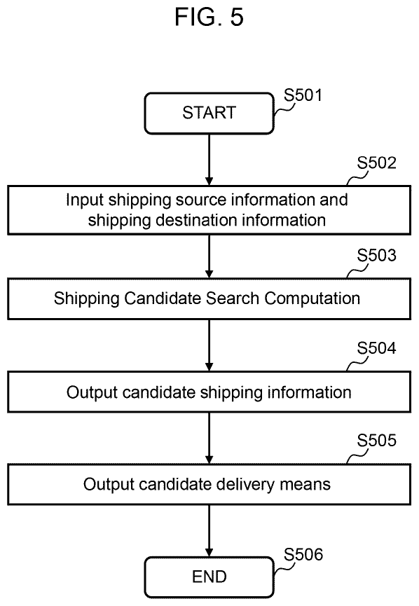

FIG. 5 is a flowchart illustrating basic operations of the food transportation assistance system Firstly, the arithmetic device 22 starts the basic operations of the food transportation assistance system 20 (step S501).

Next, the arithmetic device 22 executes the data input/output program 211, acquires the shipping source information from the terminal device 10, and acquires the shipping destination information from the terminal device 30. The shipping source information and the shipping destination information are input to the food transportation assistance system 20 via the communication I/F 23 (step S502). The shipping source information and the shipping destination information are saved in the shipping source/shipping destination information database 213.

Then, the arithmetic device 22 executes the data processing program 212 and performs shipping candidate search computation (step S503). The shipping candidate search computation is computation to search for a candidate shipping source to ship food to the shipping destination.

Next, the output device 27 outputs the candidate shipping source, which has been found by the search, as candidate shipping information (step S504). The output candidate shipping information is stored in the computation history 214.

Subsequently, the arithmetic device 22 outputs a candidate delivery means (step S505). The “candidate delivery means” is a candidate for delivery means when transporting the food from the shipping source to the shipping destination and, for example, drones, motorcycles, and trucks such as light trucks can be listed as examples of the delivery means. The output candidate delivery means is stored in the computation history 214.

Then, the arithmetic device 22 terminates the series of processing (step S506).

Moreover, the food transportation assistance system 20 can output the shipping candidate search computation and the candidate delivery means in consideration of the virtual plant factory, whose outline is explained in FIG. 2.

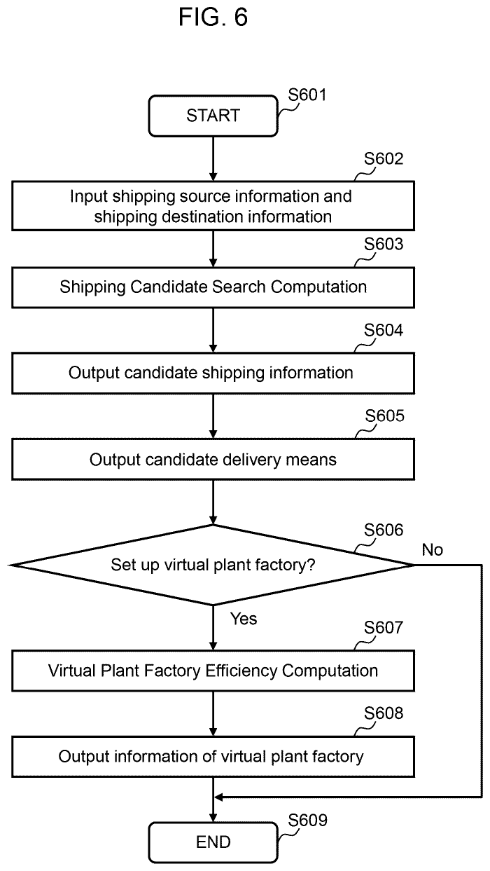

FIG. 6 is a flowchart illustrating operations of the food transportation assistance system 20 when the virtual plant factory is considered.

Since step S601 to step S605 in FIG. 5 are similar to step S501 to step S505 in FIG. 4, an explanation about them has been omitted.

In step S606 and subsequent steps, the food transportation assistance system 20 operates as follows.

The arithmetic device 22 judges whether to set up the virtual plant factory or not (step S606). This is decided by, for example, an administrator of the food transportation assistance system 20 by making the judgment of whether to set up the virtual plant factory or not by using the keyboard 25 and the mouse 26 and by the input device 24 accepting this input. Then, if it is decided, as a result of the judgment, not to set up the virtual plant factory (No in step S606), the series of processing is terminated. Specifically speaking, the result similar to the basic operations illustrated in FIG. 4 is obtained.

On the other hand, if it is decided to set up the virtual plant factory (Yes in step S606), virtual plant factory efficiency computation is performed (step S607). Although the details of the virtual plant factory efficiency computation will be described later, the virtual plant factory efficiency computation is processing for computing efficiency such as a cost required for the virtual plant factory to transport the food, which is determined by the candidate installation location of the virtual plant factory.

Then, the output device 27 outputs information of the virtual plant factory (step S608). The information of the virtual plant factory is, for example, information indicating the candidate installation location of the plant factory to be set up. Moreover, the information of the virtual plant factory is, for example, the result of the efficiency computation performed in step S607 and is the introduction efficiency of the candidate installation location of the plant factory. The output information of the virtual plant factory is displayed on, for example, the display device 28.

Consequently, the arithmetic device 22 terminates the series of processing (step S609).

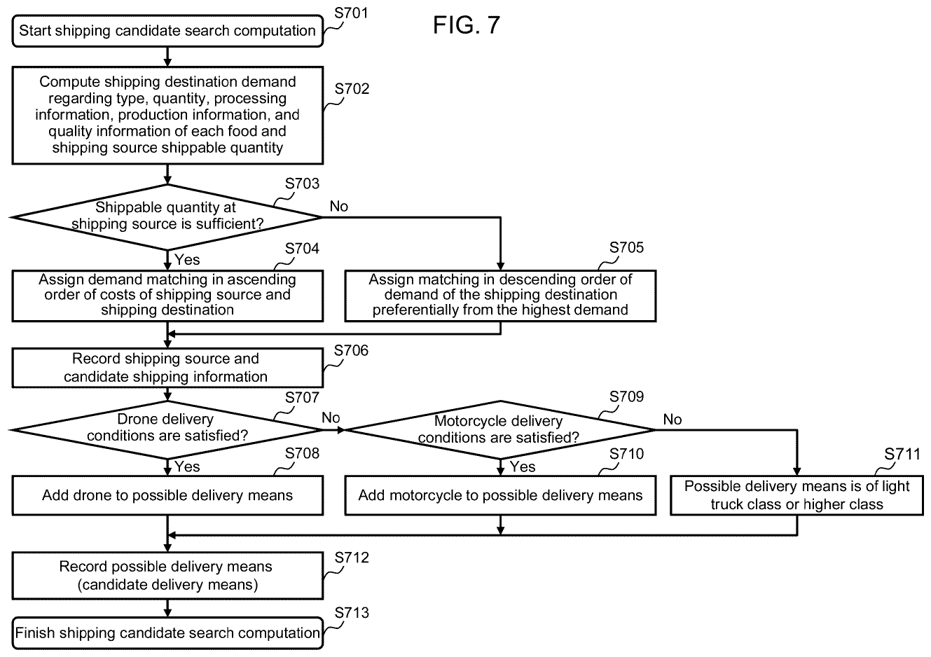

FIG. 7 is a flowchart illustrating further details of the shipping candidate search computation in step S503 in FIG. 5 and step S603 in FIG. 6.

Firstly, the arithmetic device 22 starts the shipping candidate search computation (step S701).

Next, the arithmetic device 22 computes the shipping destination's demand regarding the type, quantity, processing information, production information, quality information, etc. of each food and a shippable quantity at the shipping source (step S702).

Then, the arithmetic device 22 judges whether the shippable quantity at the shipping source satisfies the shipping destination's demand or not (step S703).

As a result, if the shippable quantity at the shipping source satisfies the shipping destination's demand (Yest in step S703), the arithmetic device 22 assigns the shipping source in ascending order of the cost (step S703). Under this circumstance, the cost is calculated based on, for example, the transportation information when transporting the food from the shipping source to the shipping destination. The “transportation information” is, for example, at least one of the transportation distance, transportation means, and transportation time from the shipping source to the shipping destination. For example, when the transportation distance is shorter, the cost becomes lower. In other words, it is possible to determine that when the distance between the shipping source and the shipping destination is shorter, the cost is lower. Moreover, when a transportation fee when using the transportation means is lower, the cost becomes lower. Furthermore, when the transportation time is shorter, the cost becomes lower. Moreover, for example, the cost can also be calculated based on whether the shipping destination's demand is high or low. In this case, if the shipping destination's demand is high, it is possible to determine that the cost is low. In other words, as the shipping destination's demand is higher, the transportation can be performed more efficiently, so that the cost becomes lower.

On the other hand, if the shippable quantity at the shipping source does not satisfy the shipping destination's demand and the shippable quantity at the shipping source is insufficient (No in step S703), the arithmetic device 22 assigns the shipping source in descending order of the shipping destination's demand (step S705).

After step S704 and step 705, the assigned candidate shipping sources are recorded as the candidate shipping information in the computation history 214 (step S706).

The processing in step S703 to step 705 can be described as matching between information about food which is included in the shipping source information and information about food which is included in the shipping destination information. The information about food in this case corresponds to the shipping destination's demand regarding the type, quantity, processing information, production information, and quality information of each food, and the shippable quantity at the shipping source. Moreover, this can also be described as calculating a matching degree between the information about food which is included in the shipping source information and the information about food which is included in the shipping destination information. Furthermore, it can also be described as finding the candidate shipping source, as the candidate shipping information, from the plurality of shipping sources based on the matching degree and the transportation information.

Accordingly, the arithmetic device 22 assigns the shipping source(s) to the food requested by the shipping destination and creates the candidate shipping information.

Next, the arithmetic device 22 registers the candidate delivery means. This corresponds to processing from step S707 to step S712.

Under this circumstance, the arithmetic device 22 judges whether drone delivery conditions are satisfied or not (step S707).

As a result, if the drone delivery conditions are satisfied (Yes in step S707), the arithmetic device 22 adds a drone as a possible delivery means (step S708).

On the other hand, if the drone delivery conditions are not satisfied (No in step S707), the arithmetic device 22 judges whether motorcycle delivery conditions are satisfied or not (step S709).

As a result, if the motorcycle delivery conditions are satisfied (Yes in step S709), the arithmetic device 22 adds a motorcycle as the possible delivery means (step S710).

On the other hand, if the motorcycle delivery conditions are not satisfied (No in step S709), the arithmetic device 22 determines that the possible delivery means will be of a light truck class or higher class (step S711).

The candidate delivery means is decided based on, for example, the distance between the shipping source and the shipping destination and the weight of food to be transported. Incidentally, regarding the sequential order of step S707 and step S709, either one of them may be performed before or after the other.

Then, the arithmetic device 22 records the possible delivery means (candidate delivery means) (step S712).

Consequently, the arithmetic device 22 terminates the shipping candidate search computation (step S713).

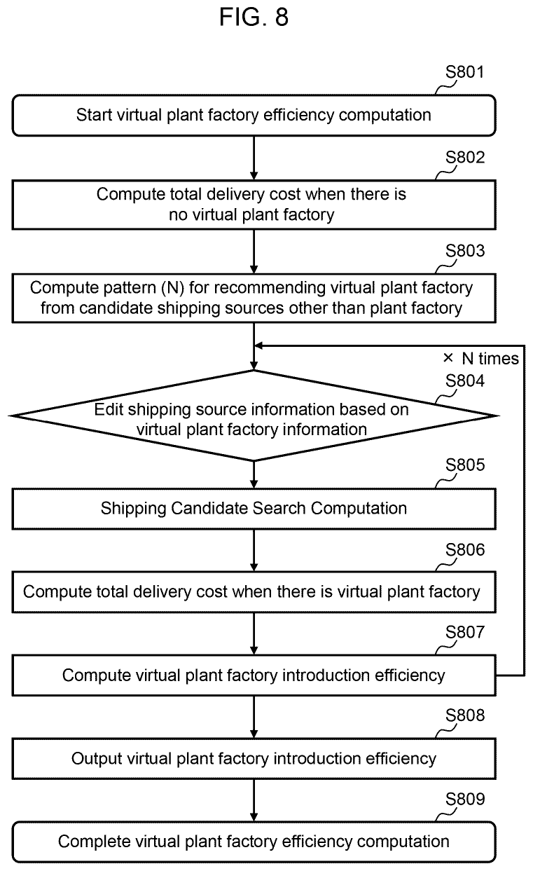

FIG. 8 is a flowchart illustrating further details of the virtual plant factory efficiency computation in step S607 in FIG. 6.

Firstly, the arithmetic device 22 starts the virtual plant factory efficiency computation (step S801).

Next, the arithmetic device 22 computes total delivery cost when there is no virtual plant factory (step S802).

Then, the arithmetic device 22 computes a pattern(s) (N) for recommending a virtual plant factory/factories from candidate shipping sources other than plant factories (step S803). This is the computation to find a location where the virtual plant factory can be introduced. This location is the location other than positions where the open-field cultivation and the plant factory/factories are already installed. For example, it may be assumed as the location(s) at each vertex or along lines between the vertexes of the network as illustrated in FIG. 2. Specifically, assuming there are three vertexes, when Vertex 1=a plant factory+open-field cultivation, Vertex 2=a residence, and Vertex 3=a wholesaler are selected, the arithmetic device 22 recommends to set up virtual plant factories at Vertex 2 and Vertex 3. Under this circumstance, there are two patterns (N)=2. A list of location(s) where the virtual plant factory/factories can be introduced is prepared and registered in advance and such location can be selected from this list. The advance list is registered as virtual plant factory information.

Now, the arithmetic device 22 performs loop computation regarding N patterns as follows. In this case, the arithmetic device 22 edits the shipping source information based on the virtual plant factory information (step S804). Specifically speaking, a virtual plant factory is included as the shipping source information.

Next, the arithmetic device 22 performs the shipping candidate search computation explained with reference to FIG. 7 (step S805).

Then, the arithmetic device 22 computes the total delivery cost when there is the virtual plant factory (step S806).

Subsequently, the arithmetic device 22 computes the virtual plant factory introduction efficiency (step S807). The virtual plant factory introduction efficiency can be computed according to, for example, Expression (1) below.

$$( Total Delivery Cost When There Is Virtual Plant Factory - Total Delivery Cost When There Is No Virtual Plant Factory ) \div Total Delivery Cost When There Is No Virtual Plant Factory \qquad ( 1 )$$

Furthermore, the arithmetic device 22 outputs the virtual plant factory introduction efficiency (step S808). The output introduction efficiency is recorded in the computation history 214. Consequently, the arithmetic device 22 completes the virtual plant factory efficiency computation (step S809).

### Description of Examples of Shipping Destination Information, Shipping Source Information, Virtual Plant Factory Information, Candidate Shipping Information, and Candidate Delivery Means

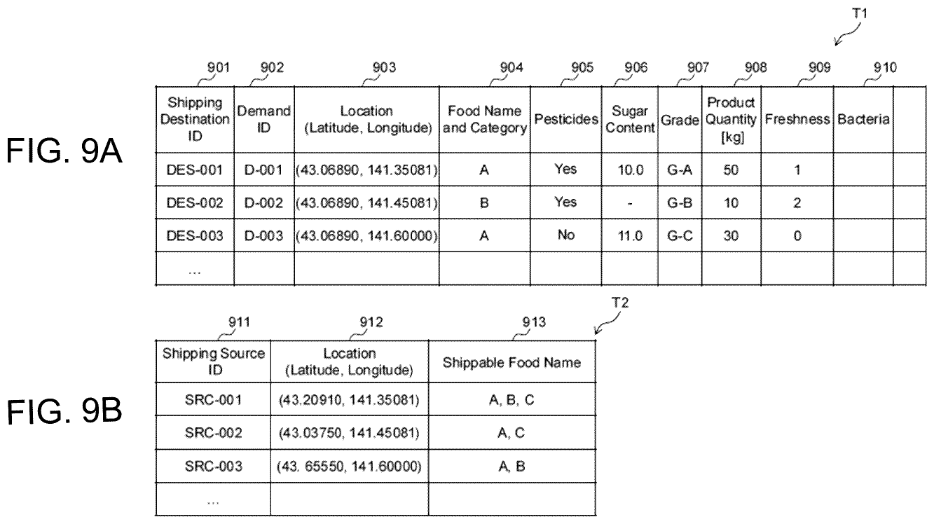

FIG. 9(a) is a diagram illustrating the shipping destination information. Here, the shipping destination information is indicated by a table T1.

As indicated in the table T1, the shipping destination information includes each information of a shipping destination ID 901, a demand ID 902, a location (latitude, longitude) 903, a food name and category 904, pesticides 905, sugar content 906, a grade 907, a product quantity 908, freshness 909, and bacteria 910.

The shipping destination ID 901 and the demand ID 902 are the ID of the shipping destination and the ID assigned to the demand requested by the shipping destination, respectively.

The location (latitude, longitude) 903 is an example of the second location information and is information indicating the location information of the shipping destination with the latitude and the longitude.

The food name and category 904 are the name of the food.

The pesticides 905 are information indicating whether pesticides are used or not, by indicating “Yes” or “No.” In a case of the open-field cultivation, there are a case where the pesticides are used and a case where the pesticides are not used; however, in a case of the plant factories, the pesticides are normally not used.

The sugar content 906 is information of the sugar content of the food.

The grade 907 is information about food rankings. Incidentally, this can vary depending on foods and may be, for example, information about size rankings such as L (large), M (medium), and S (small).

The product quantity 908 is a minimum unit when transporting the food. Here, kg is used as the unit, but it may be, for example, a unit such as “boxes.”

The freshness 909 is information of freshness rankings of the food. Here, the freshness 909 indicates, for example, three-level rankings of 0 to 2.

The bacteria 910 indicate whether the bacteria exist or not. In a case of the plant factories, it is assumed that there exist very few bacteria; and in this case, information such as “None” is given.

The shipping destination ID 901 and the demand ID 902, and the food name and category 904 through the bacteria 910 can also be recognized as examples of demand information. Moreover, the pesticides 905, the sugar content 906, the grade 907, the freshness 909, and the bacteria 910 can also be recognized as information about the food quality.

FIG. 9(b) is a diagram illustrating the shipping source information. Here, the shipping source information is indicated by a table T2.

As indicated in the table T2, the shipping source information includes each information of a shipping source ID 911, a location (latitude, longitude) 912, and a shippable food name 913.

The shipping source ID 911 is the ID of the shipping source.

The location (latitude, longitude) 912 is an example of the first location information and is information indicating location information of the shipping source with the latitude and the longitude.

The shippable food name 913 is the name of food which can be shipped from the shipping source.

The shipping source ID 911 and the shippable food name 913 can also be recognized as examples of the shipping information.

Incidentally, the table T2 may include information about shippable time indicating time when the food can be shipped.

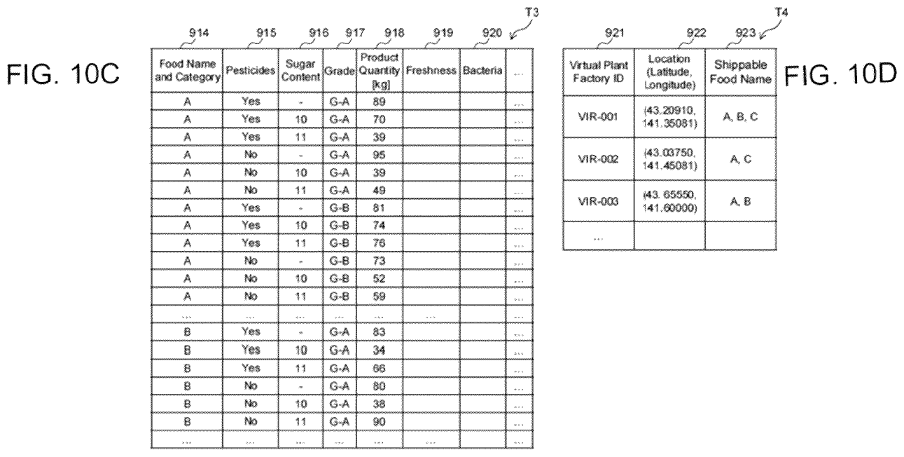

FIG. 10(c) is a diagram illustrating food information managed at the shipping source. The food information is an example of the information about food and includes information about the name and quality of the food to be shipped. Here, the food information is indicated by a table T3.

The food information includes each information of a food name and category 914, pesticides 915, sugar content 916, a grade 917, product quantity 918, freshness 919, and bacteria 920.

The food name and category 914, the pesticides 915, the sugar content 916, the grade 917, the product quantity 918, the freshness 919, and the bacteria 920 are similar to the food name and category 904, the pesticides 905, the sugar content 906, the grade 907, the product quantity 908, the freshness 909, and the bacteria 910 described above.

FIG. 10(d) is a diagram illustrating the virtual plant factory information. Here, the virtual plant factory information is indicated by a table T4.

As illustrated in the table T4, the virtual plant factory information includes each information of a virtual plant factory ID 921, a location (latitude, longitude) 922, and a shippable food name 923.

The virtual plant factory ID 921 is the ID assigned to the virtual plant factory.

The location (latitude, longitude) 922 is information indicating location information of the virtual plant factory with the latitude and the longitude.

The shippable food name 923 is the name of the food which can be shipped from the virtual plant factory.

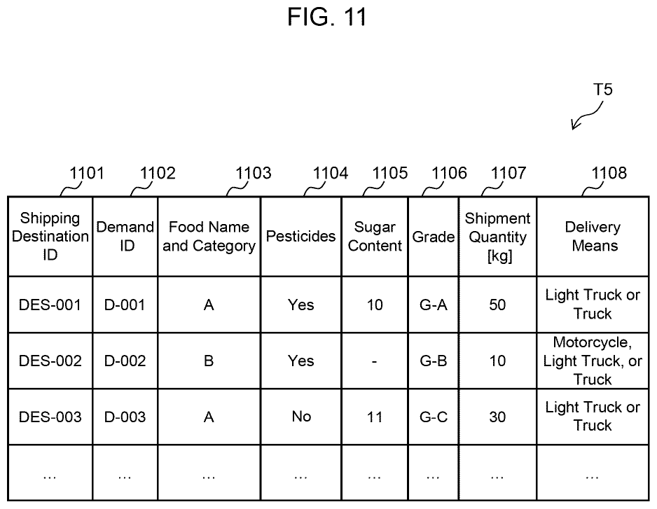

FIG. 11 is a diagram illustrating the candidate shipping information and the candidate delivery means. Here, the candidate shipping information and the candidate delivery means are indicated by a table T5.

The table T5 includes a shipping destination ID 1101, a demand ID 1102, a food name and category 1103, pesticides 1104, sugar content 1105, a grade 1106, a shipment quantity 1107, and a delivery means 1108.

The shipping destination ID 1101, the demand ID 1102, the food name and category 1103, the pesticides 1104, the sugar content 1105, and the grade 1106 are similar to the shipping destination ID 901, the demand ID 902, the food name and category 904, the pesticides 905, the sugar content 906, and the grade 907 described earlier.

The shipment quantity 1107 is the entire quantity of the food to be shipped and kg is used as the unit here. The shipping destination ID 1101 through the shipment quantity 1107 correspond to the candidate shipping information.

The delivery means 1108 is a candidate for the means for transporting the food from the shipping source to the shipping destination and corresponds to the candidate delivery means.

### Description of User Interface

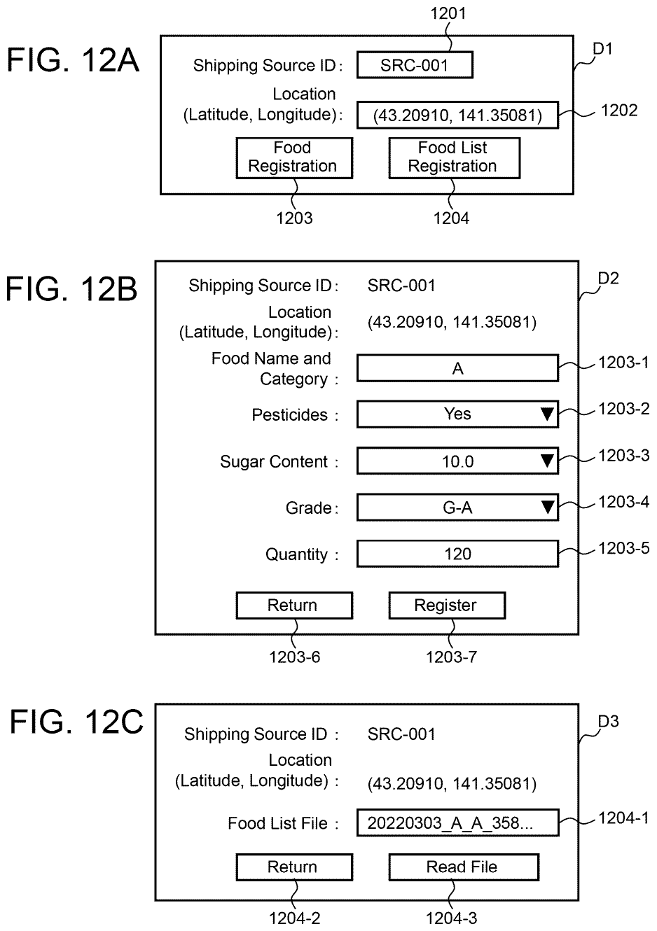

FIG. 12(a) to (c) are diagrams illustrating screens for the shipping source to input the shipping source information.

Of these diagrams, FIG. 12(a) illustrates a dialog D1 to which the shipping source inputs the shipping source ID 911 and the location (latitude, longitude) 912 indicated in FIG. 9(b).

In FIG. 12(a), the shipping source ID 911 is input to a shipping source ID input field 1201. Moreover, the location (latitude, longitude) 912 is input to a location input field 1202.

Then, when a food registration button 1203 is pressed after inputting these pieces of information, the screen is switched to a screen in FIG. 12(b).

FIG. 12(b) is a diagram illustrating a dialog D2 for individually registering the food to be shipped by the shipping source.

FIG. 12(b) shows a screen to which the shipping source inputs the food name and category 904, the pesticides 905, the sugar content 906, the grade 907, and the product quantity 908 indicated in FIG. 9.

Here, the food name and category 904 are input to a food name and category input field 1203-1. Moreover, the pesticides 905, the sugar content 906, and the grade 907 are input to a pesticides input field 1203-2, a sugar content input field 1203-3, and a grade input field 1203-4, respectively, by selecting the relevant information from a pull-down menu. Furthermore, the product quantity 908 is input to a product quantity input field 1203-5. Then, the screen returns to the screen in FIG. 12(a) by pressing a return button 1203-6,. Moreover, the food to be shipped is registered by pressing a register button 1203-7.

Moreover, when a food list registration button 1204 is pressed on the screen in FIG. 12(a), the screen is switched to a dialog D3 in FIG. 12(c).

FIG. 12(c) is a diagram illustrating a screen for the shipping source to register a list of the food to be shipped.

FIG. 12(c) illustrates a case where the shipping source registers the food to be shipped based on the information recorded in a food list file.

Here, a file name of the food list file is input to a food list file input field 1204-1.

Then, the screen returns to the screen in FIG. 12(a) by pressing a return button 1204-2. Moreover, by pressing a read file button 1204-3, the food list file is read and the food to be shipped by the shipping source is registered.

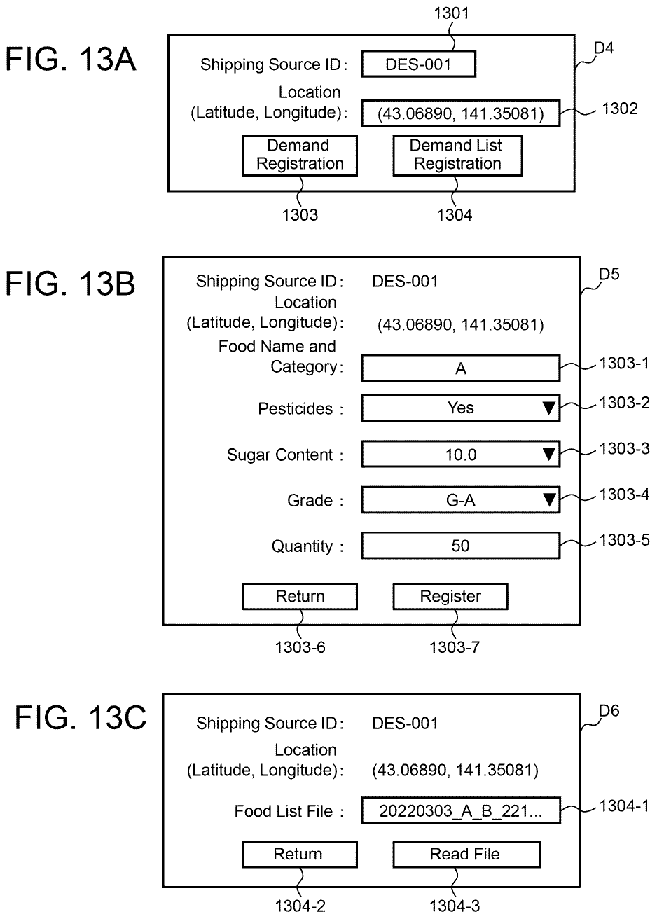

FIG. 13(a) to (c) are diagrams illustrating screens for the shipping destination to input the shipping destination information.

Of these diagrams, FIG. 13(a) illustrates a dialog D4 for the shipping destination to input the shipping destination ID 901 and the location (latitude, longitude) 902 indicated in FIG. 9(a). In FIG. 13(a), the shipping destination ID 901 is input to a shipping destination ID input field 1301. Moreover, the location (latitude, longitude) 902 is input to a location input field 1302. Then, when a demand registration button 1303 is pressed after inputting these pieces of information, the screen is switched to a screen in FIG. 13(b).

FIG. 13(b) is a diagram illustrating a dialog D5 for individually registering the food requested by the shipping destination.

FIG. 13(b) shows the screen for the shipping destination to input the food name and category 904, the pesticides 905, the sugar content 906, the grade 907, and the product quantity 908 indicated in FIG. 9.

Here, the food name and category 904 are input to a food-name-and-category input field 1303-1. Moreover, the pesticides 905, the sugar content 906, and the grade 907 are input to a pesticides input field 1303-2, a sugar content input field 1303-3, and a grade input field 1303-4, respectively, by selecting the relevant information from a pull-down menu. Furthermore, the product quantity 908 is input to a product quantity input 1303-5.

Then, the screen returns to the screen in FIG. 13(a) by pressing a return button 1303-6. Moreover, the requested food is registered by pressing a register button 1303-7.

Furthermore, when a demand list registration button 1304 is pressed on the screen in FIG. 13(a), the screen switches to a dialog D6 in FIG. 13(c).

FIG. 13(c) is a diagram illustrating a screen for registering a list of the requested food.

FIG. 13(c) shows a case where the shipping destination registers the requested food based on information recorded in the food list file.

Here, the file name of the food list file is input to a food list file input field 1304-1.

Then, the screen returns to the screen in FIG. 13(a) by pressing a return button 1304-2. Moreover, by pressing a read file button 1304-3, the food list file is read and the shipping destination registers the requested food.

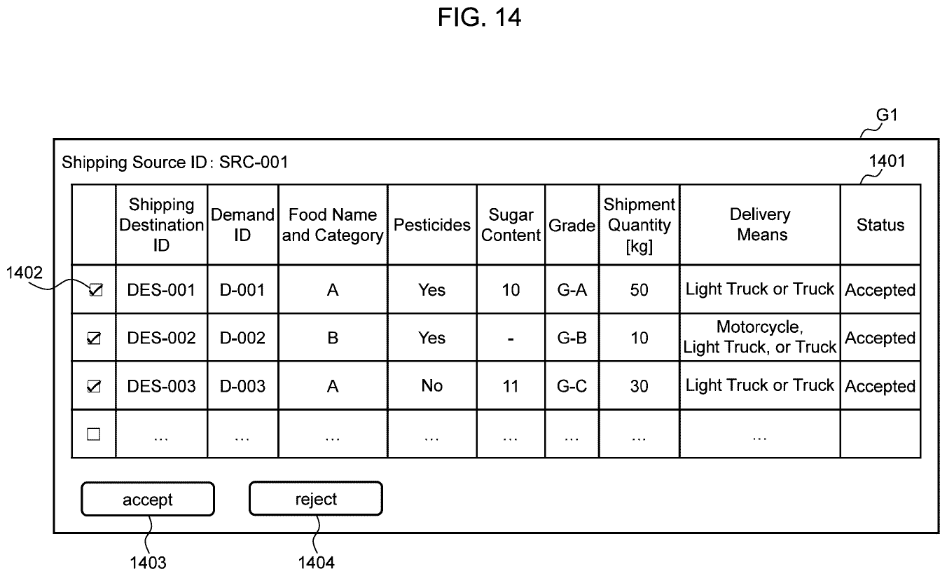

FIG. 14 is a diagram illustrating a case where the candidate shipping information and the candidate delivery means indicated in FIG. 11 are output to the shipping source. This is sent from the food transportation assistance system 20 to the shipping source and is displayed on the terminal device 10 in order to obtain an approval from the shipping source after step S506 in FIG. 5 or step S609 in FIG. 6.

A screen G1 illustrated in the diagram shows a case where the candidate shipping information and the candidate delivery means are output to the shipping source whose shipping source ID is SRC-001. The screen G1 displays the candidate shipping information and the candidate delivery means in a table 1401. Moreover, the table 1401 displays a check box 1402; and when the shipping source enters a check mark in the check box 1402 and then presses an accept button 1403, the candidate shipping information and the candidate delivery means are approved and a status column at the right end of the table 1401 shows “Accepted” indicating that the above information has been approved. Incidentally, when the shipping source enters the check mark in the check box 1402 and then presses a reject button1404, this candidate shipping information and the candidate delivery means are rejected.

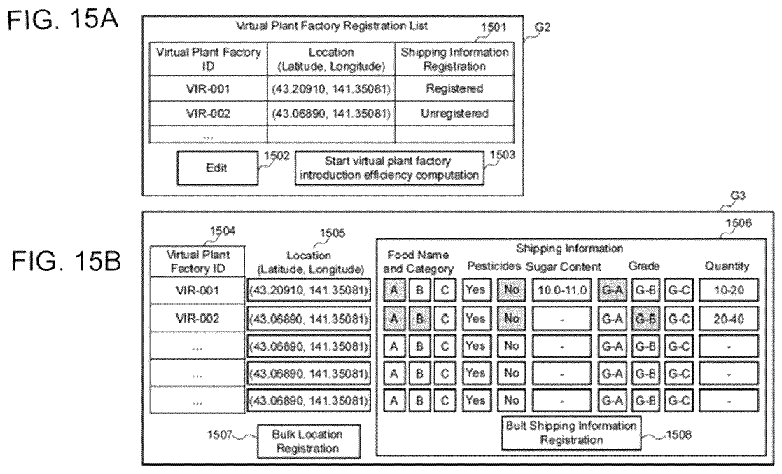

FIG. 15(a) to (b) are diagrams illustrating screens for the administrator of the food transportation assistance system 20 to input or edit a candidate installation location(s) of a virtual plant factory/factories.

Of these diagrams, a screen G2 indicated in FIG. 15(a) is a list of currently registered candidate installation locations. Here, a table 1501 displays a virtual plant factory ID, a location (latitude, longitude), and whether the shipping information is registered or not.

Then, when an edit button 1502 is pressed, the screen changes to a screen G3 illustrated in FIG. 15(b).

FIG. 15(b) is a diagram illustrating the screen G2 to input or edit the candidate installation location(s) of the virtual plant factory/factories.

Here, it is possible to input or edit a virtual plant factory ID 1504, a location (latitude, longitude) 1505, and shipping information 1506. Regarding the shipping information, it is possible to input or edit the food name and category, whether the pesticides are used or not, the sugar content, the grade, and the quantity.

Then, when a bulk location registration button 1507 is pressed, the virtual plant factory ID 1504 and the location (latitude, longitude) 1505 of candidate installation locations of the virtual plant factories are registered. Moreover, when a bult shipping information registration button 1508 is pressed, the shipping information 1506 of the virtual plant factories are registered. As a result, the food information indicated in FIG. 10(c) and the virtual plant factory information indicated in FIG. 10(d) are generated regarding the virtual plant factories.

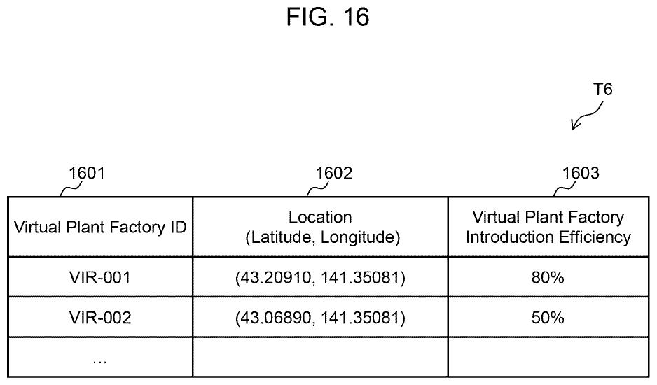

FIG. 16 is a diagram illustrating a case where the introduction efficiency is associated as the virtual plant factory information.

A table T6 indicated in the diagram includes a virtual plant factory ID 1601, a location (latitude, longitude) 1602, and introduction efficiency 1603.

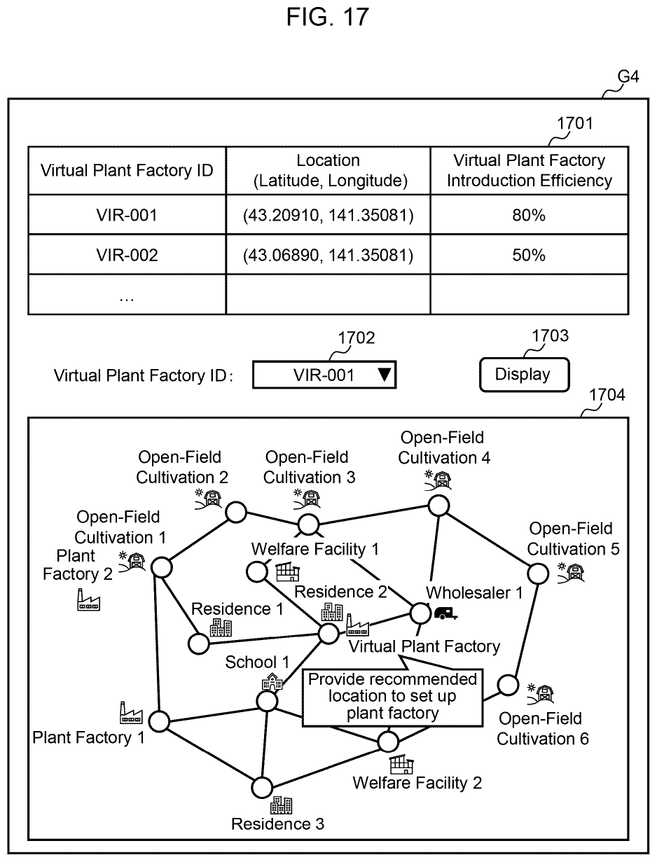

FIG. 17 illustrates a case where the information about the virtual plant factory/factories is displayed.

In an upper part of a screen G4 indicated in the diagram, a table 1701 including the virtual plant factory ID 1601, the location (latitude, longitude) 1602, and the introduction efficiency 1603 is displayed. Moreover, in a lower part of the screen G4, a map is displayed to show the location of the virtual plant factory. In this case, the virtual plant factory ID is selected by a pull-down menu 1702 and a display button 1703 is pressed, thereby displaying a map 1704.

### Description of Advantageous Effects

Conventionally, the plant factories have not been considered as the shipping sources, so that long-distance food transportation tends to happen easily. In this case, it will lead to cost increase and growing environmental burden upon the food transportation.

With the food transportation assistance system 20 which has been described above in detail, the input device 24 accepts the shipping source information (for example, the table T2 in FIG. 9(b)) including the first location information (for example, the location (latitude, longitude) 912 in FIG. 9(b)) which is the location information of a plurality of shipping sources including plant factories, and the information about food to be shipped by the shipping sources (for example, the shippable food name 913 in FIG. 9(b) and the food information in FIG. 10(c)). Moreover, the input device 24 accepts the shipping destination information (for example, the table T1 in FIG. 9(a)) including the second location information which is the location information of the shipping destination (for example, the location (latitude, longitude) 902 in FIG. 9(a)) and the information about food requested by the shipping destination (for example, the food name and category 904 through the bacteria 910 in FIG. 9(a) and the food information in FIG. 10(c)).

Moreover, the arithmetic device 22 finds the matching degree between the information about food which is included in the shipping source information and the information about food which is included in the shipping destination information, and the transportation information when transforming the food from the shipping source to the shipping destination (for example, step S703 to step S705 in FIG. 7). In this case, the transportation information is at least one of the transportation distance, the transportation means, and the transportation time from the shipping source to the shipping destination.

Then, the arithmetic device 22 finds the candidate shipping source, as the candidate shipping information, from among the plurality of shipping sources on the basis of the matching degree and the transportation information (for example, step S603 in FIG. 6 and steps S703 to S705 in FIG. 7). Under this circumstance, the arithmetic device 22 can compute the matching degree based on the shippable quantity, that is, the quantity of the food which can be shipped at the shipping source, and the cost required when transporting the food from the shipping source to the shipping destination (for example, step S702 to step S705 in FIG. 7). Then, the output device 27 outputs the shipping source and the candidate shipping information (for example, step S604 in FIG. 6).

Consequently, when the plant factories are included as the shipping sources, the food transportation assistance system 20 can propose a method for making the food transportation more efficient. Then, as the shipping source and the shipping destination actually execute this, the food transportation becomes more efficient. Accordingly, the long-distance food transportation does not occur easily and it is possible to realize the cost reduction and the reduction of the environmental burden upon the food transportation.

Moreover, with the food transportation assistance system 20 whose details are described earlier, the shipping source includes the virtual shipping location and the output device 27 outputs the virtual shipping location as the candidate installation location of the plant factory (for example, step S608 in FIG. 6). In this case, the input device 24 accepts candidates for the virtual shipping location (for example, FIG. 15), and the output device 27 outputs the candidate installation location of a plant factory selected from among the accepted candidates for the virtual shipping location (for example, FIG. 10(d), FIG. 16). Moreover, the output device 27 may output the introduction efficiency when a plant factory is set as the candidate installation location (for example, FIG. 16).

Consequently, the food transportation assistance system 20 can propose the candidate installation location of the plant factory which can make the food transportation more efficient. Then, when the plant factory is actually set up, for example, the plant factory can be also set up in a city area where the open-field cultivation cannot be conducted, so that the role of complementing the open-field cultivation is fulfilled.

Moreover, the arithmetic device 22 further computes the candidate delivery means which is a candidate for the transportation means when shipping the food from the shipping source to the shipping destination (for example, step S707 to step S712 in FIG. 7). Then, the output device 27 outputs the candidate delivery means (for example, the delivery means 1108 in FIG. 11).

Consequently, the food transportation assistance system 20 can propose the method for making the food transportation including the transportation means more efficient; and as the shipping source and the shipping destination actually executing this, the food transportation becomes more efficient.

### Description of Food Transportation Assistance Method

The above-described processing performed by the food transportation assistance system 20 is implemented by cooperation between software and hardware resources. Specifically speaking, a processor inside a computer provided in the food transportation assistance system 20 loads the software for implementing the aforementioned respective functions to a memory and executes it, thereby implementing these respective functions.

Therefore, the processing performed by the food transportation assistance system 20 can be recognized as the food transportation assistance method including, by execution of the software recorded in the memory by the processor: accepting the shipping source information including the first location information, which is the location information of a plurality of shipping sources including plant factories, and information about food to be shipped by a shipping source, and the shipping destination information including second location information, which is location information of a shipping destination, and information about food requested by the shipping destination; finding the matching degree between the information about food which is included in the shipping source information and the information about food which is included in the shipping destination information, and the transportation information when transporting the food from the shipping source to the shipping destination; and outputting candidate shipping information, which is a candidate shipping source, from among the plurality of shipping sources on the basis of the matching degree and the transportation information.

This embodiment has been described above, but the technical scope of the present invention is not limited to the scope described in the above-described embodiment. It is obvious from the description of the scope of the patent claims that the above-described embodiment with various changes or improvements added thereto is also included within the technical scope of the present invention.

### REFERENCE SIGNS LIST

1: food transportation system
10a, 10b: terminal devices
20: food transportation assistance system
21: storage device
22: arithmetic device
23: communication I/F
24 input device
27: output device
30a, 30b, 30c, 30: terminal devices
T1 to T6: tables
D1 to D6: dialogs
G1 to G4: screens

1. A food transportation assistance system comprising:
an input device that accepts shipping source information including first location information, which is location information of a plurality of shipping sources including plant factories, and information about food to be shipped by a shipping source, and shipping destination information including second location information, which is location information of a shipping destination, and information about food requested by the shipping destination;
an arithmetic device that finds a matching degree between the information about food which is included in the shipping source information and the information about food which is included in the shipping destination information, and transportation information when transporting the food from the shipping source to the shipping destination; and
an output device that outputs a candidate shipping source as candidate shipping information from among the plurality of shipping sources on the basis of the matching degree and the transportation information.

2. The food transportation assistance system according to claim 1,
wherein the shipping source includes a virtual shipping location; and
wherein the output device outputs the virtual shipping location as a candidate installation location of a plant factory.

3. The food transportation assistance system according to claim 2,
wherein the input device accepts a candidate for the virtual shipping location; and
wherein the output device outputs the candidate installation location of a plant factory selected from among accepted candidates for the virtual shipping location.

4. The food transportation assistance system according to claim 3,
wherein the output device outputs introduction efficiency when setting the plant factory as the candidate installation location.

5. The food transportation assistance system according to claim 4,
wherein the introduction efficiency is decided based on a cost required for food transportation.

6. The food transportation assistance system according to claim 1,
wherein the output device further outputs a candidate delivery means that is a candidate for a transportation means when shipping the food from the shipping source to the shipping destination.

7. The food transportation assistance system according to claim 6,
wherein the candidate delivery means is decided based on a distance between the shipping source and the shipping destination, and weight of the food to be transported.

8. The food transportation assistance system according to claim 1,
wherein the arithmetic device computes the matching degree based on a shippable quantity of the food which can be shipped from the shipping source, and a cost required when transporting the food from the shipping source to the shipping destination.

9. The food transportation assistance system according to claim 1,
wherein the candidate shipping information is sent to the shipping source in order to obtain an approval from the shipping source.

10. The food transportation assistance system according to claim 1,
wherein the transportation information is at least one of a transportation distance, a transportation means, and transportation time from the shipping source to the shipping destination.

11. A food transportation assistance method comprising, by execution of software recorded in a memory by a processor:
accepting shipping source information including first location information, which is location information of a plurality of shipping sources including plant factories, and information about food to be shipped by a shipping source, and shipping destination information including second location information, which is location information of a shipping destination, and information about food requested by the shipping destination;
finding a matching degree) between the information about food which is included in the shipping source information and the information about food which is included in the shipping destination information, and transportation information when transporting the food from the shipping source to the shipping destination; and
outputting a candidate shipping source as candidate shipping information from among the plurality of shipping sources on the basis of the matching degree and the transportation information.

12. A food transportation system comprising:
a first terminal device that inputs shipping source information including first location information, which is location information of a plurality of shipping sources including plant factories, and information about food to be shipped by a shipping source;
a second terminal device that inputs second location information, which is location information of a shipping destination, and information about food requested by the shipping destination; and
a food transportation assistance system that outputs candidate shipping information which is a candidate shipping source when shipping food from the shipping source to the shipping destination,
wherein the food transportation assistance system includes:
an input device that accepts the shipping source information and the shipping destination information;
an arithmetic device that finds a matching degree between the information about food which is included in the shipping source information and the information about food which is included in the shipping destination information, and transportation information when transporting the food from the shipping source to the shipping destination; and
an output device that outputs the candidate shipping source as the candidate shipping information from among the plurality of shipping sources on the basis of the matching degree and the transportation information.
